(19) United States
(12) Patent Application Publication
(10) Pub. No.: US 2026/0312905 A1
(43) Pub. Date: Oct. 8, 2026

(54) Multi-NIC load balancing

(71) Applicant: Mellanox Technologies, Ltd., Yokneam (IL)

(72) Inventors: Gil Bloch, Zichron Ya'acov (IL); Salvatore Di Girolamo, Zurich (CH); Petrus Gootzen, Zwolle (NL); Roman Nudelman, Danville, CA (US)

(21) Appl. No.: 19/171,390

(22) Filed: Apr. 7, 2025

(51) Int. Cl. H04L 47/122; H04L 47/52

(52) U.S. Cl. CPC H04L 47/122; H04L 47/522

(57) ABSTRACT

In one embodiment, a system includes at least one processing element to process data associated with multiple traffic flows, and a plurality of network devices coupled to the at least one processing element, the network devices being to process the multiple traffic flows according to bandwidth shares assigned to the multiple traffic flows such that each traffic flow is processed concurrently by the plurality of network devices according to a respective bandwidth share, wherein each network device of the plurality of network devices includes processing circuitry to compare an expected progress with an actual progress for each traffic flow, and dynamically adjust the respective bandwidth share for each traffic flow based on the comparison, wherein the dynamic adjustment is performed by each network device to promote processing fairness of the traffic flows among the plurality of network devices.

### FIELD OF INVENTION

The present disclosure relates to computing systems, and more particularly but not exclusively to load balancing for multiple NICs.

### BACKGROUND

Modern high-performance computing systems, data centers, and network infrastructure often employ multiple network interface controllers (NICs) per node to handle increasing network traffic demands. These multi-NIC configurations are designed to provide higher aggregate bandwidth, improved fault tolerance, and the ability to handle multiple simultaneous network connections.

In a typical multi-NIC system, one or more processing elements (e.g., CPUs, GPUs) are connected to multiple NICs through a system interconnect such as PCIe. These processing elements generate multiple traffic flows, where each flow represents a stream of data to be transmitted over the network. Traditionally, each NIC would handle separate flows independently, or flows would be statically assigned to specific NICs.

The aggregate bandwidth provided by multiple NICs offers potential for improved network performance. However, effectively utilizing this bandwidth while maintaining fairness between flows and respecting quality of service (QoS) requirements presents challenges. Considerations include ensuring equitable bandwidth distribution among flows, prioritizing certain flows based on their importance or time-sensitivity, adapting to changing network conditions and flow demands in real-time, compensating for performance issues on individual NICs, and scaling efficiently to systems with large numbers of NICs and flows.

Existing approaches often rely on centralized controllers to monitor all NICs and flows, actively adjusting bandwidth allocation. However, these centralized approaches can introduce latency, create single points of failure, and struggle to scale to large systems. Additionally, they may not react quickly enough to rapid changes in network conditions or flow demands.

As computing systems continue to evolve and network traffic demands increase, there is ongoing interest in developing distributed, scalable, and adaptive methods for load balancing and fairness across multiple NICs that can maintain optimal performance without relying on centralized control or extensive inter-NIC communication.

### OVERVIEW

There is provided in accordance with an embodiment of the present disclosure, a system, comprising at least one processing element to process data associated with multiple traffic flows, and a plurality of network devices coupled to the at least one processing element, the network devices being to process the multiple traffic flows according to bandwidth shares assigned to the multiple traffic flows such that each traffic flow is processed concurrently by the plurality of network devices according to a respective bandwidth share, wherein each network device of the plurality of network devices includes processing circuitry to compare an expected progress with an actual progress for each traffic flow, and dynamically adjust the respective bandwidth share for each traffic flow based on the comparison, wherein the dynamic adjustment is performed by each network device to promote processing fairness of the traffic flows among the plurality of network devices.

Further in accordance with an embodiment of the present disclosure, the system further comprising other network devices which are not processing the multiple traffic flow.

Still further in accordance with an embodiment of the present disclosure, the processing circuitry of each network device is to acquire exclusive ownership of a next set of data to be processed for each traffic flow atomically.

Additionally in accordance with an embodiment of the present disclosure, the processing circuitry of each network device is to increase the respective bandwidth share for a traffic flow when the actual progress is less than the expected progress, and decrease the respective bandwidth share for the traffic flow when the actual progress is greater than the expected progress.

Moreover, in accordance with an embodiment of the present disclosure, the processing circuitry of each network device is to compute the expected progress based on a total number of the network devices serving each traffic flow and a function of the bandwidth share for each traffic flow.

Further in accordance with an embodiment of the present disclosure, the processing circuitry of each network device is to compare the expected progress with the actual progress for each traffic flow at respective scheduling iterations.

Still further in accordance with an embodiment of the present disclosure, the bandwidth shares assigned to the multiple traffic flows enable quality-of-service differentiation between the traffic flows.

Additionally in accordance with an embodiment of the present disclosure, the processing circuitry is to dynamically adjust the respective bandwidth share for each traffic flow based on any one or more of the following, congestion control data, queue states of other flows, historical performance data, or current network conditions.

There is provided in accordance with another embodiment of the present disclosure, a network device, comprising a network interface to share traffic flows over a network with at least one remote device, and processing circuitry to receive bandwidth share assignments for multiple traffic flows, wherein each traffic flow is processed concurrently by a plurality of network devices, compare an expected progress with an actual progress for each traffic flow, and dynamically adjust the respective bandwidth share for each traffic flow based on the comparison, wherein the dynamic adjustment is performed by the processing circuitry to promote processing fairness of the traffic flows among the plurality of network devices.

Further in accordance with an embodiment of the present disclosure, the processing circuitry is to acquire exclusive ownership of a next set of data to be processed for each traffic flow atomically.

Still further in accordance with an embodiment of the present disclosure, the processing circuitry is to increase the respective bandwidth share for a traffic flow when the actual progress is less than the expected progress, and decrease the respective bandwidth share for the traffic flow when the actual progress is greater than the expected progress.

Additionally in accordance with an embodiment of the present disclosure, the processing circuitry is to compute the expected progress based on a total number of the network devices serving each traffic flow and a function of the bandwidth share for each traffic flow.

Moreover, in accordance with an embodiment of the present disclosure, the processing circuitry is to compare the expected progress with the actual progress for each traffic flow at respective scheduling iterations.

Further in accordance with an embodiment of the present disclosure, the bandwidth shares assigned to the multiple traffic flows enable quality-of-service differentiation between the traffic flows.

Still further in accordance with an embodiment of the present disclosure, the processing circuitry is to dynamically adjust the respective bandwidth share for each traffic flow based on any one or more of the following, congestion control data, queue states of other flows, historical performance data, or current network conditions.

There is also provided in accordance with still another embodiment of the present disclosure, a system, comprising at least one processing element to process data associated with a traffic flow, and a plurality of network devices coupled to the at least one processing element, the network devices being to process the traffic flow according to a bandwidth share assigned to the traffic flow such that the traffic flow is processed concurrently by the plurality of network devices according to the bandwidth share, wherein each network device of the plurality of network devices includes processing circuitry to compare an expected progress with an actual progress for the traffic flow, and dynamically adjust the bandwidth share for the traffic flow based on the comparison.

Further in accordance with an embodiment of the present disclosure, the processing circuitry of each network device is to acquire exclusive ownership of a next set of data to be processed for the traffic flow atomically.

Still further in accordance with an embodiment of the present disclosure, the processing circuitry of each network device is to increase the bandwidth share for the traffic flow when the actual progress is less than the expected progress, and decrease the bandwidth share for the traffic flow when the actual progress is greater than the expected progress.

Additionally in accordance with an embodiment of the present disclosure, the processing circuitry of each network device is to compute the expected progress based on a total number of the network devices serving the traffic flow and a function of the bandwidth share for the traffic flow.

Moreover, in accordance with an embodiment of the present disclosure, the processing circuitry of each network device is to compare the expected progress with the actual progress for the traffic flow at respective scheduling iterations.

There is also provided in accordance with still another embodiment of the present disclosure, a network device, comprising a network interface to share a traffic flow over a network with at least one remote device, and processing circuitry to receive a bandwidth share assignment for the traffic flow, wherein the traffic flow is processed concurrently by a plurality of network devices, compare an expected progress with an actual progress for the traffic flow, and dynamically adjust the bandwidth share for the traffic flow based on the comparison.

Further in accordance with an embodiment of the present disclosure, the processing circuitry is to acquire exclusive ownership of a next set of data to be processed for the traffic flow atomically.

Still further in accordance with an embodiment of the present disclosure, the processing circuitry is to increase the bandwidth share for the traffic flow when the actual progress is less than the expected progress, and decrease the bandwidth share for the traffic flow when the actual progress is greater than the expected progress.

Additionally in accordance with an embodiment of the present disclosure, the processing circuitry is to compute the expected progress based on a total number of the network devices serving the traffic flow and a function of the bandwidth share for the traffic flow.

Moreover, in accordance with an embodiment of the present disclosure, the processing circuitry is to compare the expected progress with the actual progress for the traffic flow at respective scheduling iterations.

There is also provided in accordance with still another embodiment of the present disclosure, a method, comprising processing multiple traffic flows according to bandwidth shares assigned to the multiple traffic flows such that each traffic flow is processed concurrently by a plurality of network devices according to a respective bandwidth share, comparing an expected progress with an actual progress for each traffic flow, and dynamically adjusting the respective bandwidth share for each traffic flow based on the comparison, wherein the dynamic adjustment is performed to promote processing fairness of the traffic flows among the plurality of network devices.

There is also provided in accordance with still another embodiment of the present disclosure, a method, comprising receiving bandwidth share assignments for multiple traffic flows, wherein each traffic flow is processed concurrently by a plurality of network devices, comparing an expected progress with an actual progress for each traffic flow, and dynamically adjusting the respective bandwidth share for each traffic flow based on the comparison, wherein the dynamic adjustment is performed to promote processing fairness of the traffic flows among the plurality of network devices.

### BRIEF DESCRIPTION OF THE DRAWINGS

The present disclosure will be understood from the following detailed description, taken in conjunction with the drawings in which:

FIG. 1 is a simplified block diagram of a computing system constructed and operative in accordance with an embodiment of the present disclosure;

FIG. 2 is a more detailed block diagram of a network interface controller of FIG. 1;

FIG. 3 is a simplified pictorial illustration of a multi-NIC system with work queues, in accordance with an embodiment of the present disclosure;

FIG. 4 is a flowchart including steps in a method of data acquisition for the system of FIG. 3;

FIG. 5 is a simplified pictorial illustration of dynamic bandwidth allocation in a multi-NIC system, in accordance with an embodiment of the present disclosure;

FIG. 6 is a flowchart including steps in a method of managing bandwidth allocation across multiple network interface controllers; and

FIG. 7 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

As previously mentioned, modern high-performance computing systems, data centers, and network infrastructure often employ multiple network interface controllers (NICs) per node to handle increasing network traffic demands. While these multi-NIC configurations offer higher aggregate bandwidth and improved fault tolerance, effectively utilizing this bandwidth while maintaining fairness between flows and respecting quality of service (QoS) requirements presents several challenges. Current approaches to managing bandwidth in multi-NIC systems often rely on centralized controllers to monitor all NICs and flows, actively adjusting bandwidth allocation. However, these centralized approaches can introduce latency, create single points of failure, and struggle to scale to large systems. Additionally, they may not react quickly enough to rapid changes in network conditions or flow demands.

Embodiments of the present disclosure address at least some of the above drawbacks by providing a system and method for distributed load balancing across multiple NICs that maintains fairness and QoS without relying on centralized control or extensive inter-NIC communication.

In some embodiments, the NICs may be replaced by any suitable network device for example, but not limited to, a NIC, a data processing unit (DPU), a system on chip (SoC), a graphic processing unit (GPU), or a network interface that is integrated into any other processing unit.

In some embodiments, the system allows any given data flow to be processed concurrently by multiple NICs. Each NIC independently adjusts the bandwidth shares of traffic flows based on local observations, comparing expected progress with actual progress for each flow.

In some embodiments, the system includes at least one processing element (e.g., central processing unit(s) (CPU(s)) and/or graphic processing unit(s) (GPU(s)) to process data associated with multiple traffic flows, and a plurality of NICs coupled to the processing elements. The NICs process the multiple traffic flows according to bandwidth shares assigned to each flow, with each flow being processed concurrently by multiple NICs according to its respective bandwidth share.

Each NIC may include processing circuitry that compares an expected progress with an actual progress for each traffic flow. Based on this comparison, the NIC dynamically adjusts the respective bandwidth share for each flow. This dynamic adjustment may be performed independently by each NIC to promote processing fairness of the traffic flows among the plurality of NICs.

In some aspects, the processing circuitry of each NIC may acquire exclusive ownership of a next set of data to be processed for each traffic flow atomically. This atomic acquisition may help prevent multiple NICs from acquiring the same data bytes, ensuring consistency and efficiency in data processing.

The system may increase the respective bandwidth share for a traffic flow when the actual progress is less than the expected progress, and decrease the share when the actual progress is greater than the expected progress. This adaptive approach allows the system to respond to changing network conditions and flow demands in real-time. This mechanism allows a NIC to compensate for other NICs that may be experiencing processing difficulties with certain flows.

In some cases, the expected progress may be computed based on factors such as the total number of NICs serving each traffic flow and a function of the bandwidth share for each flow. The comparison between expected and actual progress may occur at respective scheduling iterations, allowing for regular adjustments to maintain optimal performance.

The bandwidth shares assigned to the multiple traffic flows may enable quality-of-service differentiation between the flows. This allows the system to prioritize certain flows based on their importance or time-sensitivity while still maintaining overall fairness.

In some implementations, the processing circuitry may dynamically adjust the respective bandwidth share for each traffic flow based on additional factors. These may include congestion control data, queue states of other flows, historical performance data, or current network conditions. This multi-faceted approach to bandwidth allocation allows for more sophisticated and context-aware adjustments.

The distributed nature of this approach offers several advantages. It can quickly adapt to changing network conditions and flow demands in real-time. The system scales efficiently to large numbers of NICs and flows without introducing significant computational or communication overhead. Additionally, it provides inherent fault tolerance, as the failure or slowdown of one NIC is automatically compensated for by the others.

### System Description

In some cases, the following definitions may apply to terms used throughout this disclosure:

A “traffic flow” may refer to a stream of data to be transmitted over a network. In some cases, a traffic flow may be divided into fixed-size chunks for processing. A traffic flow may be a network flow. As used herein, a “network flow” may refer to a sequence of related packets or data units that share common characteristics and are transmitted between a source and destination over a network. Network flows may be identified by attributes such as source and destination IP addresses, port numbers, protocol types, or other identifiers. In some implementations, a network flow may represent a logical connection or communication session between network endpoints, and may persist for varying durations depending on the nature of the data transfer or application requirements.

A “bandwidth share” may refer to a portion of the total available network bandwidth allocated to a particular traffic flow. The bandwidth share may be represented by a parameter that defines the relative amount of bandwidth a flow is intended to use.

“Quality of service” may refer to the ability to prioritize certain traffic flows over others based on their importance or time-sensitivity, while still maintaining overall fairness.

“Fairness” in the context of network traffic processing may refer to ensuring that each traffic flow receives an equitable share of the total available bandwidth according to its assigned bandwidth share.

A “network interface controller (NIC)” may refer to a hardware component that connects a computing device to a network. In some cases, multiple NICs may be present in a single system to handle increasing network traffic demands.

A “scheduling iteration” may refer to a cycle during which NICs serve one or more traffic flows. At each iteration, NICs may process data from different traffic flows according to their assigned bandwidth shares.

A “data chunk” may refer to a fixed-size portion of a traffic flow that can be processed independently. In some cases, NICs may use work queues to manage the processing of these data chunks for different traffic flows, for example, based on work requests which define the data chunks to be processed. Each work request may refer to one or more data chunks to be processed.

As used herein, a “data processing unit (DPU)” may refer to a specialized processor that combines networking, storage, and compute capabilities to offload and accelerate data-intensive tasks from a main central processing unit. A DPU may include network interfaces, programmable processing cores, and memory to handle data movement and processing independently.

As used herein, a “system on chip (SoC)” may refer to an integrated circuit that incorporates multiple components of a computer or electronic system onto a single chip. An SoC may include processors, memory, input/output ports, and other digital and analog functions integrated on one substrate.

As used herein, a “graphics processing unit (GPU)” may refer to a specialized electronic circuit designed to rapidly manipulate and alter memory to accelerate the creation of images in a frame buffer intended for output to a display device. GPUs may also be used for general-purpose computing tasks that can benefit from parallel processing.

As used herein, a “network interface that is integrated into any other processing unit” may refer to a network communication component that is built directly into another type of processor, such as a CPU, GPU, or SoC. This integrated network interface may provide network connectivity without requiring a separate network interface card, potentially improving efficiency and reducing overall system complexity.

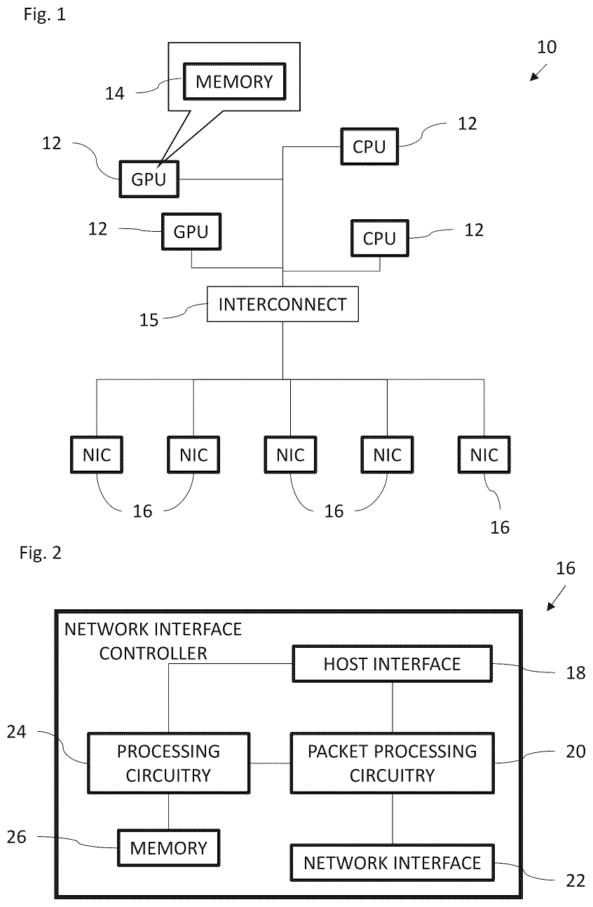

Reference is now made to FIG. 1, which is a block diagram of a computing system 10. The computing system 10 may include one or more processing units 12 and multiple network interface controllers 16.

In some cases, the processing unit(s) 12 may be one or more central processing units (CPU(s)) and/or one or more graphics processing units (GPU(s)). The multiple processing units 12 may be connected to the network interface controllers 16 via a system interconnect 15, such as Peripheral Component Interconnect Express (PCIe).

Each processing unit 12 may include memory 14 to store data and instructions for that processing unit. The network interface controllers 16 may process both incoming and outgoing traffic flows between the computing system 10 and external networks.

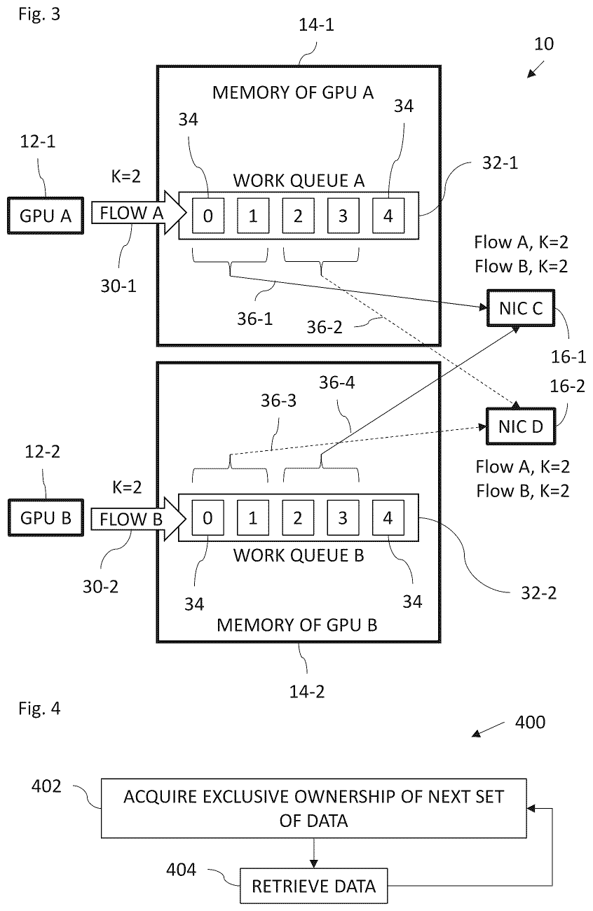

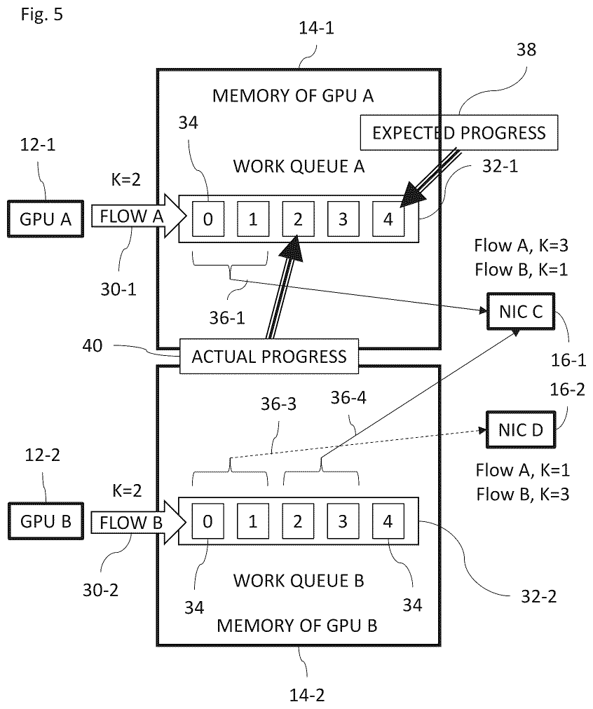

In some cases, the processing unit(s) 12 may generate multiple traffic flows to be transmitted over a network. The network interface controllers 16 may process these traffic flows concurrently, distributing the workload across multiple network interface controllers 16. This concurrent processing may allow for efficient utilization of available network bandwidth. In some cases, a traffic flow or more than one traffic flow may be processed concurrently by the network interface controllers 16. For example, two NICs may both process flows A and B concurrently, as described below in more detail with reference to FIGS. 3 and 5.

As used herein, the term “concurrently” may refer to a processing pattern where multiple flows are interleaved over a given time period. In this context, concurrently may not necessarily mean that blocks from different flows are processed simultaneously. Instead, it may involve processing at least one block from a first flow, followed by at least one block from a second flow, then returning to process at least one block from the first flow, and so on, all within the same time period. This interleaved processing approach may allow for the handling of multiple flows in a quasi-parallel manner, even if individual blocks from different flows are not processed at the exact same instant.

The network interface controllers 16 may also receive incoming traffic flows from external networks. These incoming flows may be processed by the network interface controllers 16 and forwarded to the appropriate processing unit(s) 12 within the computing system 10.

The interaction between the processing unit(s) 12 and network interface controllers 16 may enable the computing system 10 to handle complex networking tasks efficiently. By leveraging multiple network interface controllers 16, the computing system 10 may achieve higher aggregate bandwidth and improved fault tolerance compared to systems with a single network interface controller.

Reference is now made to FIG. 2, which is a detailed block diagram of one of the network interface controllers 16. The network interface controller 16 may include several internal components for processing network traffic flows.

Network interface controller 16 may include a host interface 18 for communicating with other components of a computing system such as the processing unit(s) 12. The host interface 18 may enable the network interface controller 16 to exchange data and control information with processing unit(s) 12 and other devices within the computing system 10.

The network interface controller 16 may include packet processing circuitry 20 connected to the host interface 18. The packet processing circuitry 20 may be configured to perform operations such as packet segmentation, reassembly, and classification on network traffic flows.

The network interface controller 16 may include a network interface 22 coupled to the packet processing circuitry 20 for external network communications. The network interface 22 may be configured to enable the network interface controller 16 to send data to, or receive data from, at least one remote device over a network. In some cases, the network interface 22 may include physical layer circuitry for transmitting and receiving network signals.

The network interface controller 16 may also include processing circuitry 24 connected to the host interface 18 and packet processing circuitry 20. The processing circuitry 24 may be connected to the packet processing circuitry 20. The processing circuitry 24 may manage the overall operation of the network interface controller 16, including coordinating data movement between components and implementing traffic flow management algorithms.

The processing circuitry 24 may be coupled to NIC memory 26 for local data storage. The NIC memory 26 may store configuration information, packet buffers, and other data used in processing network traffic flows.

In some cases, the processing circuitry 24 may manage data flow between the host interface 18, packet processing circuitry 20, and NIC memory 26. This may enable efficient handling of traffic flows as data moves through the network interface controller 16.

The network interface controller 16 may process network traffic flows through coordination between the host interface 18, packet processing circuitry 20, processing circuitry 24, NIC memory 26, and network interface 22. In some cases, the processing circuitry 24 may monitor and adjust bandwidth allocation for different traffic flows processed by the network interface controller 16, as described in more detail with reference to FIGS. 3-6.

Reference is now made to FIG. 3, which is a block diagram illustrating multiple NICs with work queues in the system 10 of FIG. 1. FIG. 3 illustrates two NICs for the sake of simplicity.

The system 10 comprises a first processing unit 12-1 and a second processing unit 12-2 to process data associated with traffic flows. In some cases, the first processing unit 12-1 and the second processing unit 12-2 may be GPUs (as shown in FIG. 3) or CPUs, or a CPU and a GPU. The system also comprises a first network interface controller 16-1 and a second network interface controller 16-2 coupled to the first processing unit 12-1 and the second processing unit 12-2.

A first traffic flow 30-1 (flow A) and a second traffic flow 30-2 (flow B) are associated with the first processing unit 12-1 and the second processing unit 12-2, respectively. The traffic flows may be generated by the processing units 12-1, 12-2. In some embodiments, the traffic flows may be generated by a single processing unit.

Each traffic flow may be assigned a bandwidth share parameter, denoted as “K” in FIG. 3. In the illustrated example, both the first traffic flow 30-1 and the second traffic flow 30-2 are assigned a bandwidth share parameter K=2, for the sake of simplicity. Therefore, in the example of FIG. 3, the flows are allocated the same value of the bandwidth share parameter. However, flows may be allocated different values of the bandwidth share parameter.

The system includes a first work queue 32-1 and a second work queue 32-2, which may be stored in memory 14-1 and 14-2 accessible by the processing units 12-1, 12-2, respectively, and network interface controllers 16. The memory could be in the memory of the same processing unit or on a different processing unit. For example, a GPU may establish a work queue in the memory of a CPU or another GPU.

The first work queue 32-1 and the second work queue 32-2 may include work requests that describe the work to be performed and indicators to the block or blocks to be processed. These work requests may be in the form of work queue entries or elements (WQEs). In some implementations, the indicators may be links or pointers to the specific data blocks that need processing.

In some cases, the work queue may directly include the blocks to be processed, rather than work requests. For the sake of simplicity in the illustrations and descriptions that follow, the work queues are depicted as containing the actual blocks to be processed. However, it should be understood that the methods described herein for adjusting the processing rate of the work queues according to the progress of the work queues may also be applied when the work queues include work requests instead of the actual data blocks.

The work requests, when present, may contain information such as the type of operation to be performed, the priority of the task, and any specific parameters required for processing. This structure allows for flexible management of work distribution across multiple NICs, as the work requests can be easily queued, prioritized, and distributed based on the current system state and processing requirements.

The first work queue 32-1 and the second work queue 32-2 contain multiple data chunks 34. In some cases, the data chunks 34 may represent units of work or data to be processed by the network interface controllers. The first processing unit 12-1 may process the first traffic flow 30-1 (flow A) and add corresponding data chunks 34 to the first work queue 32-1 (work queue A). Similarly, the second processing unit 12-2 may process the second traffic flow 30-2 (flow B) and add corresponding data chunks 34 to the second work queue 32-2 (work queue B). In some cases, the processing units 12 may generate work requests that define the data chunks to be processed, and these work requests may be added to the respective work queues. The network interface controllers 16-1 (NIC C) and 16-2 (NIC D) may then retrieve and process these data chunks or work requests from the work queues according to their assigned bandwidth shares. For example, if K=2, the relevant NIC retrieves 2 chunks of data at a time from the corresponding work queue.

The first network interface controller 16-1 and the second network interface controller 16-2 process the multiple traffic flows according to the assigned bandwidth shares. Each traffic flow may be processed concurrently by both network interface controllers. Lines 36-1, 36-2, 36-3, and 36-4 illustrate the connections and data flow between the processing units, work queues, and network interface controllers.

FIG. 3 shows first network interface controller 16-1 acquiring the first two chunks 34 (e.g., chunk 0 and chunk 1) from work queue A (line 36-1). Similarly, the second network interface controller 16-2 may acquire chunks 34 (e.g., chunk 2 and 3) from work queue A (line 36-2). This retrieval process may continue sequentially, with the first network interface controller 16-1 acquiring subsequent chunks (e.g., chunks 4 and 5) in later iterations, and so on. When the work queue includes work requests referring to data chunks, NIC 16-1 fetches the relevant work request(s), and then fetches the data chunk(s) from wherever they are indicated in the work request(s), rather than directly from the work queue. The acquisition by the NICs is performed on the chunks. Therefore, if the work queues include work requests, the acquisition by the NICs is on the chunks and not on the work queues.

FIG. 3 also shows second network interface controller 16-2 acquiring the first two chunks 34 (e.g., chunk 0 and chunk 1) from work queue B (line 36-3). Similarly, the first network interface controller 16-1 may acquire chunks 34 (e.g., chunk 2 and 3) from the work queue B (line 36-4). This retrieval process may continue sequentially, with the first network interface controller 16-2 acquiring subsequent chunks (e.g., chunks 4 and 5) in later iterations, and so on.

This interleaved retrieval process allows both network interface controllers 16 to process multiple traffic flows concurrently, potentially improving overall system efficiency and bandwidth utilization. The number of chunks retrieved by each network interface controller may vary based on factors such as the assigned bandwidth shares, current network conditions, and the state of the work queues.

The processing circuitry 24 of each network interface controller 16 may receive bandwidth share assignments for the multiple traffic flows from the processing devices 12 or an orchestration node. These assignments determine how the network interface controllers allocate their processing resources among the traffic flows.

Reference is now made to FIG. 4, which illustrates a flowchart 400 depicting a data acquisition process that may be performed by the processing circuitry 24 of each network interface controller 16. The flowchart 400 includes a block 402 for acquiring exclusive ownership of the next set of data, followed by a block 404 for retrieving the data.

In some cases, the processing circuitry 24 of each network interface controller may be configured to acquire exclusive ownership of the next set of data to be processed for each traffic flow atomically. This atomic acquisition may be implemented using operations such as fetch-and-add or compare-and-swap. By acquiring exclusive ownership, the network interface controllers 16 ensure that no two controllers process the same data chunk, promoting efficient distribution of work across the multiple network interface controllers 16.

The bandwidth share assignments and atomic data acquisition process allow the system to manage multiple traffic flows efficiently, ensuring fair allocation of resources and preventing conflicts in data processing across the network interface controllers.

Reference is now made to FIG. 5, which is a block diagram illustrating dynamic bandwidth allocation in multi-NIC system 10.

In some cases, if the processing of flow A by NIC 16-1 (NIC C) and NIC 16-2 (NIC D) proceeds as expected, NIC C may acquire and process blocks 0 and 1, while NIC D may acquire and process blocks 2 and 3. Subsequently, NIC C may acquire and process blocks 4 and 5, and this pattern may continue in a similar manner. However, if NIC D encounters a problem with processing flow A, the system may adapt to maintain overall fairness and efficiency.

In such a scenario, the effective bandwidth share parameter K of flow A for NIC D may be reduced from 2 to 1. Concurrently, the effective bandwidth share parameter of flow B for NIC D may increase from 2 to 3. This adjustment may occur due to the spare capacity provided by not processing flow A according to its originally assigned bandwidth share parameter.

To compensate for this imbalance, NIC C may adjust its processing of the flows. In some aspects, NIC C may increase its effective bandwidth share parameter for flow A from 2 to 3, while reducing its effective bandwidth share parameter for flow B from 2 to 1. This adaptive approach may help maintain overall fairness in the processing of both flows across the two NICs.

The system may implement these adjustments dynamically, based on ongoing monitoring of the actual progress of each flow compared to the expected progress. By making these compensatory changes, the system may strive to maintain the intended aggregate bandwidth allocation for each flow, even when one NIC experiences processing difficulties.

In some implementations, the processing circuitry 24 of each NIC 16 may periodically reassess the situation and further adjust the effective bandwidth share parameters as needed. This ongoing adaptation may allow the system 10 to respond to changing conditions and maintain optimal performance across multiple traffic flows 30 and NICs 16.

In some cases, processing circuitry 24 of each NIC 16 is configured to compare an expected progress 38 with an actual progress 40 for each traffic flow. The expected progress 38 and actual progress may be measured using any suitable unit, such as byte offset or chunk indicator. The processing circuitry 24 may be configured to compute the expected progress 38 based on a total number of the network interface controllers 16 serving each traffic flow and a function of the bandwidth share K for each traffic flow. For example, if K=2 for the given traffic flow and there are 4 NICs processing that flow, the expected progress for NIC A may be equal to the offset of the chunk previously acquired by NIC A plus 8 (i.e., 2×4). If NIC A previously acquired chunks 2 and 3, then the expected progress would be equal to chunk 10 (i.e., 2 plus 8 (i.e., 2×4).

The share of aggregated bandwidth Bᵢ for a flow i may be computed as:

$${B}_{i} = {B}_{TOT} \times \frac{{K}_{i}}{{\sum }_{j = 0}^{j < N} {K}_{j}}$$

Where B_{TOT} may represent the total aggregate injection bandwidth across all NICs, Kᵢ may be the bandwidth share parameter for flow i, and N may be the total number of traffic flows, and j is an index. This formula may allow the system to allocate different bandwidth shares for each flow, potentially enabling quality-of-service differentiation between flows.

The processing circuitry 24 of each network interface controller 16 may be configured to compare the expected progress 38 with the actual progress 40 for each traffic flow at respective scheduling iterations, for example, when data is acquired from the respective work queues 32 by the NICs 16 for processing. Based on this comparison, the processing circuitry 24 may dynamically adjust the respective bandwidth share for each traffic flow.

In some cases, when the actual progress 40 is less than the expected progress 38 for a traffic flow, the processing circuitry 24 may increase the respective bandwidth share for that traffic flow. Conversely, when the actual progress 40 is greater than the expected progress 38, the processing circuitry 24 may decrease the respective bandwidth share for the traffic flow.

The bandwidth share adjustment may be based on a simple increment or decrement, or more complex heuristics depending on the specific implementation. In some cases, the processing circuitry may consider additional factors such as congestion control data, queue states of other flows, historical performance data, or current network conditions when deciding on the size of the bandwidth share adjustments.

By dynamically adjusting bandwidth shares based on the comparison between expected and actual progress, the system 10 may maintain fair processing of traffic flows across multiple network interface controllers without requiring centralized control.

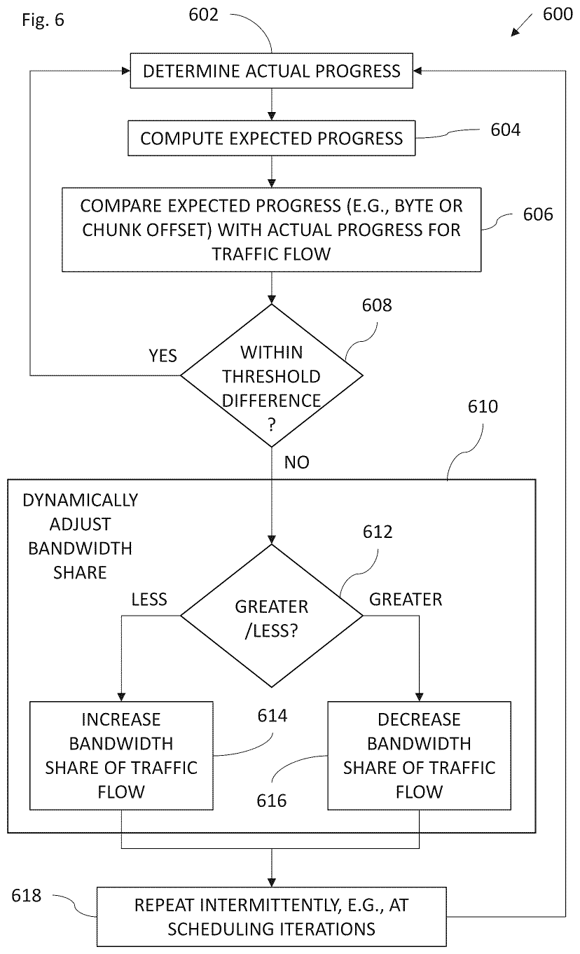

Reference is now made to FIG. 6, which is a flowchart illustrating a method 600 for managing bandwidth allocation for a given traffic flow by each network interface controller (NIC) 16 processing the same traffic flow. The method 600 is generally performed for each traffic flow by each NIC 16.

The method 600 includes several steps for dynamically adjusting bandwidth shares based on comparisons between expected and actual progress of traffic flows. The processing circuitry 24 of NIC 16 may be configured to perform one or more of the steps of blocks 602-618 described below.

The method 600 begins at a block 602, where actual progress of a given traffic flow is determined. This may involve measuring the current byte offset or chunk offset processed for the given traffic flow. At a block 604, the method 600 computes expected progress for the given traffic flow. The expected progress may be calculated based on the assigned bandwidth share and the total number of NICs processing the given traffic flow. For example, if K=2 for the given traffic flow and there are 4 NICs processing that flow, the expected progress for NIC A may be equal to the offset of the chunk previously acquired by NIC A plus 8 (i.e., 2×4). If NIC A previously acquired chunks 2 and 3, then the expected progress would be equal to chunk 10 (i.e., 2 plus 8 (i.e., 2×4).

The method 600 proceeds to a block 606, where the expected progress is compared with the actual progress for the given traffic flow. This comparison allows the system to determine if the given traffic flow is being processed as expected or if adjustments are needed.

At an optional decision block 608, the method 600 determines whether the difference between the expected and actual progress is within a threshold difference. If the difference is within the threshold (“yes” branch from decision block 608), the method 600 returns to block 602 to continue monitoring. If the difference is not within the threshold (“no” branch from decision block 608), the method 600 proceeds to a block 610 to dynamically adjust the bandwidth share. The step of block 608 allows the system to ignore small differences between the actual progress and the expected progress. In some embodiments, the threshold may be set to zero, so that any differences between the actual progress and the expected progress lead to an adjustment of the bandwidth share for the given traffic flow being analyzed.

As part of the step of block 610, at a decision block 612, the method 600 evaluates whether the actual progress is greater or less than expected. If the actual progress is less than expected (“less” branch from decision block 612), the method 600 proceeds to block 614 to increase the bandwidth share of the given traffic flow. If the actual progress is greater than expected (“greater” branch from decision block 612), the method 600 proceeds to a block 616 to decrease the bandwidth share of the given traffic flow. The magnitude of the adjustment to the bandwidth share may be a function of the difference between the expected and actual progress and/or depend on other factors such as congestion control data, queue states of other flows, historical performance data, or current network conditions.

After either block 614 or block 616, the method 600 proceeds to a block 618, where the process repeats intermittently, for example at scheduling iterations (e.g., when data of the traffic flow is acquired by the NIC 16). From block 618, the method 600 returns to block 602 to continue monitoring and adjusting bandwidth allocation.

In some cases, the dynamic adjustment of bandwidth shares may be based on various factors beyond the simple comparison of expected and actual progress. For example, the processing circuitry may consider queue states of other flows when adjusting the bandwidth share for a particular flow. This allows the system to balance resources across multiple traffic flows more effectively.

The processing circuitry may also take into account current network conditions when making bandwidth share adjustments. For instance, if network congestion is detected on a particular path, the bandwidth share for affected flows may be adjusted accordingly.

In some implementations, the processing circuitry 24 may utilize congestion control data to inform bandwidth share adjustments. This may involve analyzing information about network congestion points or bottlenecks to optimize flow distribution across available NICs.

Additionally, the processing circuitry 24 may consider historical performance data when dynamically adjusting bandwidth shares. By analyzing past performance trends for different flows and network conditions, the system may make more informed decisions about how to allocate bandwidth resources.

By incorporating these various factors into the bandwidth share adjustment process, the method 600 allows for a more sophisticated and adaptive approach to managing traffic flows across multiple NICs. This may result in improved overall system performance and more efficient utilization of available network resources.

In some cases, a network interface controller (NIC) device may include processing circuitry to receive bandwidth share assignments for multiple traffic flows. The bandwidth share assignments may specify relative proportions of available bandwidth to allocate to each traffic flow. For example, a first traffic flow may be assigned 60% of the available bandwidth while a second traffic flow is assigned 40%.

The processing circuitry may receive the bandwidth share assignments from various sources. In some implementations, the assignments may be received from a centralized network management system. In other cases, the assignments may be determined locally by the NIC device based on observed network conditions or application requirements. The bandwidth share assignments may also be dynamically updated over time as network conditions or priorities change.

In some implementations, the processing circuitry may use different methods for calculating the expected progress of traffic flows beyond comparing byte offsets. For example, the expected progress may be calculated based on packet counts, data transfer rates, or more complex metrics that account for variations in packet sizes or priorities.

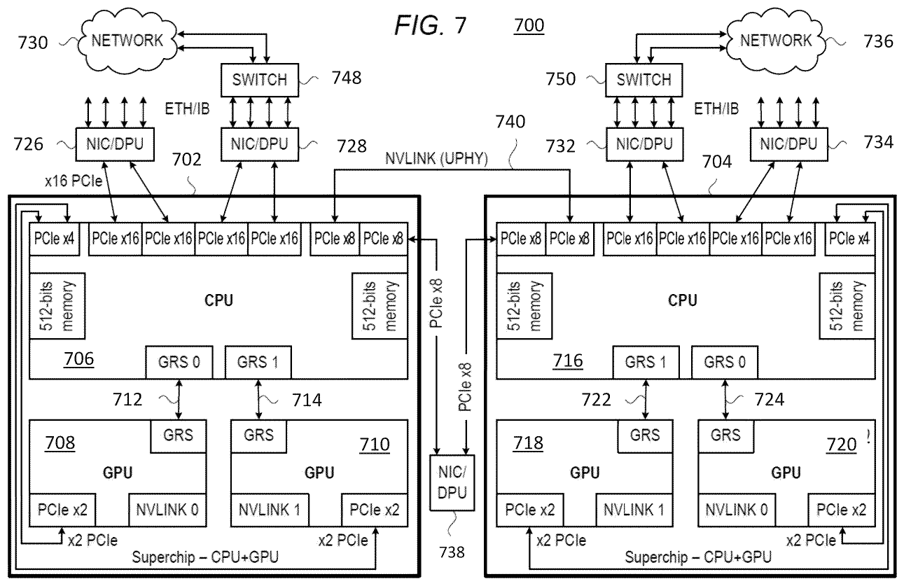

Reference is now made to FIG. 7, which is a block diagram that schematically illustrates a computing system 700, e.g., a data center or a High-Performance Computing (HPC) cluster, in accordance with an embodiment of the present disclosure.

System 700 comprises a plurality of subsystems, e.g., multiple processing devices coupled to each other, multiple network devices, and multiple networks, according to at least one embodiment. Computing system 700 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 700 and to one or more external networks 730, 736. In the present example, system 700 comprises a packet switch 748 that connects NIC/DPU 728 to network 730, and a packet switch 750 that connects NIC/DPU 732 to network 736.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 700 can include one or more CPUs and one or more GPUs.

FIG. 7 also demonstrates an example architecture of a multi-GPU architecture. As illustrated in the figure, computing system 700 includes a processing device 702 with a multi-GPU architecture. In particular, processing device 702 may be a system-on-chip and includes multiple subsystems such as a CPU 706, a GPU 708, and a GPU 710. CPU 706 can be coupled to GPU 708 via a die-to-die (D2D) or chip-to-chip (C2C) interconnect 712, such as a Ground-Referenced Signaling interconnect (GRS interconnect). CPU 706 can be coupled to GPU 710 via a D2D or C2C interconnect 714. CPU 706 can also couple to GPU 708 and GPU 710 via PCIe interconnects.

CPU 706 can be coupled to one or more NICs or DPUs, which are coupled to one or more networks. For example, as illustrated in FIG. 7, CPU 706 is coupled to a first NIC/DPU 726, which is coupled to a network 730. CPU 706 is also coupled to a second NIC/DPU 728, which is coupled to network 730 via switch 748. NIC/DPU 726 and NIC/DPU 728 can be coupled to network 730 over Ethernet (ETH), NVLINK or InfiniBand (IB) connections, for example.

Computing system 700 also includes a processing device 704 with a multi-GPU architecture. In particular, processing device 704 includes multiple subsystems including a CPU 716, a GPU 718, and a GPU 720. CPU 716 can be coupled to GPU 718 via a D2D or C2C interconnect 722. CPU 716 can be coupled to GPU 720 via a D2D or C2C interconnect 724. CPU 716 can also couple to GPU 718 and GPU 720 via PCIe interconnects. CPU 716 can be coupled to one or more NICs or DPUs, which are coupled to one or more networks. For example, as illustrated in FIG. 7, CPU 716 is coupled to a first NIC/DPU 732, which is coupled to a network 736. CPU 716 is also coupled to a second NIC/DPU 734, which is coupled to network 736 via switch 750. NIC/DPU 732 and NIC/DPU 734 can be coupled to network 736 over Ethernet (ETH), NVLINK or InfiniBand (IB) connections.

In at least one embodiment, processing device 702 and processing device 704 can communicate with each other via a NIC/DPU 738, such as over PCIe interconnects. Processing device 702 and processing device 704 can also communicate with each other over a high-bandwidth communication interconnect 740, such as an NVLink interconnect or other high-speed interconnects. The packet switches in FIG. 7 may comprise, for example, Nvidia Quantum-2 switches. The NICs/DPUs in the figure may comprise, for example, Nvidia Bluefield DPUs.

The processing unit may be any suitable device, such as: an accelerator device; a processing device including a central processing unit (CPU) and/or a graphics processing unit (GPU); a host device connected to one or more peripheral devices; a peripheral device connected to another peripheral device and/or one or more host devices; a network device, e.g., a network interface controller (NIC) device, a data processing unit (DPU) or smart NIC including a NIC and one or more processing cores, or a network switch. One or more of the processing steps described herein may be performed by a CPU, GPU, DPU, NIC, or any suitable combination thereof.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer's motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer's memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC's operation, such as speed settings, interrupt configurations, and buffer sizes; firmware/ROM that contains the embedded software that controls the NIC's operations and manages network protocols.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

1. A system, comprising:
at least one processing element to process data associated with multiple traffic flows; and
a plurality of network devices coupled to the at least one processing element, the network devices being to process the multiple traffic flows according to bandwidth shares assigned to the multiple traffic flows such that each traffic flow is processed concurrently by the plurality of network devices according to a respective bandwidth share;
wherein each network device of the plurality of network devices includes processing circuitry to:
compare an expected progress with an actual progress for each traffic flow; and
dynamically adjust the respective bandwidth share for each traffic flow based on the comparison, wherein the dynamic adjustment is performed by each network device to promote processing fairness of the traffic flows among the plurality of network devices.

2. The system according to claim 1, further comprising other network devices which are not processing the multiple traffic flow.

3. The system according to claim 1, wherein the processing circuitry of each network device is to acquire exclusive ownership of a next set of data to be processed for each traffic flow atomically.

4. The system according to claim 1, wherein the processing circuitry of each network device is to:
increase the respective bandwidth share for a traffic flow when the actual progress is less than the expected progress; and
decrease the respective bandwidth share for the traffic flow when the actual progress is greater than the expected progress.

5. The system according to claim 1, wherein the processing circuitry of each network device is to compute the expected progress based on a total number of the network devices serving each traffic flow and a function of the bandwidth share for each traffic flow.

6. The system according to claim 1, wherein the processing circuitry of each network device is to compare the expected progress with the actual progress for each traffic flow at respective scheduling iterations.

7. The system according to claim 1, wherein the bandwidth shares assigned to the multiple traffic flows enable quality-of-service differentiation between the traffic flows.

8. The system according to claim 1, wherein the processing circuitry is to dynamically adjust the respective bandwidth share for each traffic flow based on any one or more of the following: congestion control data; queue states of other flows; historical performance data; or current network conditions.

9. A network device, comprising:
a network interface to share traffic flows over a network with at least one remote device; and
processing circuitry to:
receive bandwidth share assignments for multiple traffic flows, wherein each traffic flow is processed concurrently by a plurality of network devices;
compare an expected progress with an actual progress for each traffic flow; and
dynamically adjust the respective bandwidth share for each traffic flow based on the comparison, wherein the dynamic adjustment is performed by the processing circuitry to promote processing fairness of the traffic flows among the plurality of network devices.

10. The device according to claim 9, wherein the processing circuitry is to acquire exclusive ownership of a next set of data to be processed for each traffic flow atomically.

11. The device according to claim 9, wherein the processing circuitry is to:
increase the respective bandwidth share for a traffic flow when the actual progress is less than the expected progress; and
decrease the respective bandwidth share for the traffic flow when the actual progress is greater than the expected progress.

12. The device according to claim 9, wherein the processing circuitry is to compute the expected progress based on a total number of the network devices serving each traffic flow and a function of the bandwidth share for each traffic flow.

13. The device according to claim 9, wherein the processing circuitry is to compare the expected progress with the actual progress for each traffic flow at respective scheduling iterations.

14. The device according to claim 9, wherein the bandwidth shares assigned to the multiple traffic flows enable quality-of-service differentiation between the traffic flows.

15. The device according to claim 9, wherein the processing circuitry is to dynamically adjust the respective bandwidth share for each traffic flow based on any one or more of the following: congestion control data; queue states of other flows; historical performance data; or current network conditions.

16. A system, comprising:
at least one processing element to process data associated with a traffic flow; and
a plurality of network devices coupled to the at least one processing element, the network devices being to process the traffic flow according to a bandwidth share assigned to the traffic flow such that the traffic flow is processed concurrently by the plurality of network devices according to the bandwidth share;
wherein each network device of the plurality of network devices includes processing circuitry to:
compare an expected progress with an actual progress for the traffic flow; and
dynamically adjust the bandwidth share for the traffic flow based on the comparison.

17. The system according to claim 16, wherein the processing circuitry of each network device is to acquire exclusive ownership of a next set of data to be processed for the traffic flow atomically.

18. The system according to claim 16, wherein the processing circuitry of each network device is to:
increase the bandwidth share for the traffic flow when the actual progress is less than the expected progress; and
decrease the bandwidth share for the traffic flow when the actual progress is greater than the expected progress.

19. The system according to claim 16, wherein the processing circuitry of each network device is to compute the expected progress based on a total number of the network devices serving the traffic flow and a function of the bandwidth share for the traffic flow.

20. The system according to claim 16, wherein the processing circuitry of each network device is to compare the expected progress with the actual progress for the traffic flow at respective scheduling iterations.

21. A network device, comprising:
a network interface to share a traffic flow over a network with at least one remote device; and
processing circuitry to:
receive a bandwidth share assignment for the traffic flow, wherein the traffic flow is processed concurrently by a plurality of network devices;
compare an expected progress with an actual progress for the traffic flow; and
dynamically adjust the bandwidth share for the traffic flow based on the comparison.

22. The device according to claim 21, wherein the processing circuitry is to acquire exclusive ownership of a next set of data to be processed for the traffic flow atomically.

23. The device according to claim 21, wherein the processing circuitry is to:
increase the bandwidth share for the traffic flow when the actual progress is less than the expected progress; and
decrease the bandwidth share for the traffic flow when the actual progress is greater than the expected progress.

24. The device according to claim 21, wherein the processing circuitry is to compute the expected progress based on a total number of the network devices serving the traffic flow and a function of the bandwidth share for the traffic flow.

25. The device according to claim 21, wherein the processing circuitry is to compare the expected progress with the actual progress for the traffic flow at respective scheduling iterations.
